(19) United States
(12) Patent Application Publication
(10) Pub. No.: US 2016/0352007 A1
(43) Pub. Date: Dec. 1, 2016

(54) HOUSING, ELECTRONIC DEVICE HAVING THE HOUSING, AND METHOD FOR MANUFACTURING THE HOUSING

(71) Applicants: Fu Tai Hua Industry (Shenzhen) Co., Ltd., Shenzhen (CN); HON HAI PRECISION INDUSTRY CO., LTD., New Taipei (TW)

(72) Inventors: CHANG-HAI GU, Shenzhen (CN); WU-ZHENG OU, New Taipei (TW); CHAO-HSUN LIN, New Taipei (TW); XIAO-KAI LIU, Shenzhen (CN)

(21) Appl. No.: 15/078,178

(22) Filed: Mar. 23, 2016

(30) Foreign Application Priority Data
May 28, 2015 (CN) 201510281153.2

(51) Int. Cl. H01Q 1/42; H01Q 1/24

(52) U.S. Cl. CPC H01Q 1/42; H01Q 1/24

(57) ABSTRACT

A housing includes a metallic base defining a slit, a plurality of metallic members arranged in the slit at intervals, and a non-conductive member formed between each two neighboring metallic members and between the metallic base and the metallic members adjacent to the metallic base. The plurality of the metallic pieces and the metallic base are connected by the non-conductive member. An electronic device including the housing and a method of manufacturing the housing are also provided.

### FIELD

The subject matter herein generally relates to a housing, an electronic device having the housing, and a method for manufacturing the housing.

### BACKGROUND

Metallic housings are widely used in electronic devices, such as mobile phones or personal digital assistants (PDAs). The metallic housing of the electronic device has superior hardness and duration as compared to plastic housing. Antennas are also important components in electronic devices. But the signal of the antenna located in the metal housing is often shielded by the metal housing.

### BRIEF DESCRIPTION OF THE DRAWINGS

Implementations of the present technology will now be described, by way of example only, with reference to the attached figures.

FIG. 1 is an isometric view of one embodiment of an electronic device.

FIG. 2 is a partial, enlarged view of a part of the electronic device shown in FIG. 1.

FIG. 3 is an exploded, enlarged view of the electronic device shown in FIG. 2.

FIG. 4 is similar to FIG. 3, but viewed from another aspect.

FIG. 5 is an isometric view of a metallic member of one embodiment.

FIG. 6 is similar to FIG. 5, but viewed from another aspect.

FIG. 7 is an isometric view of the housing in manufacturing process before a non-conductive portion is formed.

FIG. 8 is a partial, enlarged view of the housing shown in FIG. 7.

FIG. 9 is an isometric view of the housing in manufacturing process after the non-conductive portion is formed.

FIG. 10 is an exploded view of the metallic members.

FIG. 11 is a flow chart of a method for manufacturing the housing.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

Several definitions that apply throughout this disclosure will now be presented.

The term “coupled” is defined as coupled, whether directly or indirectly through intervening components, and is not necessarily limited to physical connections. The connection can be such that the objects are permanently coupled or releastably coupled. The term “comprising” when utilized, means “including, but not necessarily limited to”; it specifically indicates open-ended inclusion or membership in the so-described combination, group, series and the like.

The present disclosure is described in relation to a housing, an electronic device including the housing, and a method of manufacturing the housing.

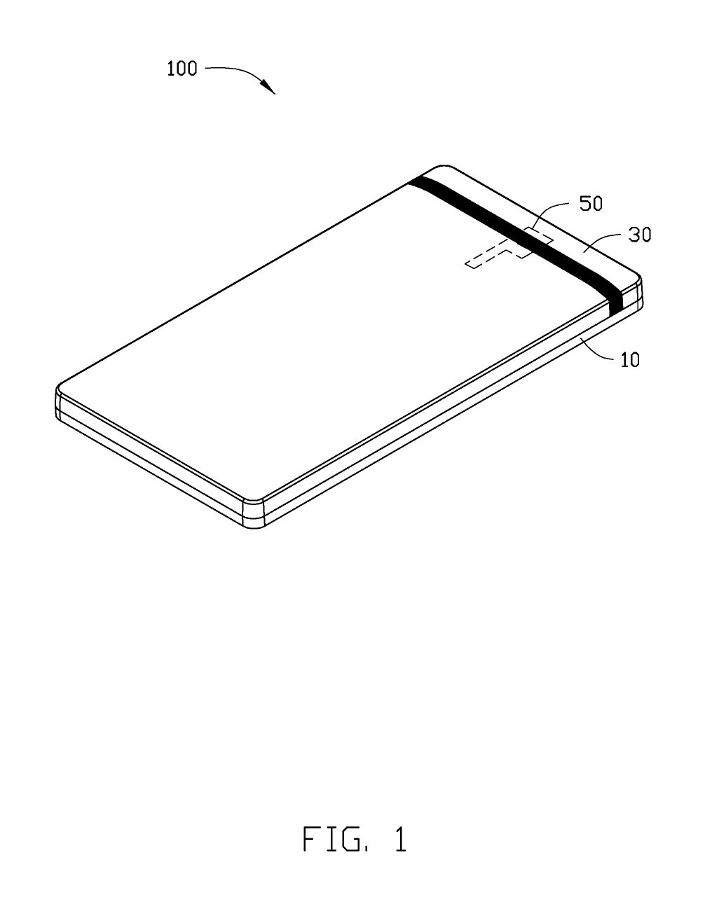

FIG. 1 illustrates that an electronic device 100 can include a display module 10, a housing 30, and an antenna 50. The display module 10 can be arranged on the housing 30 and partially received in the housing 30. The antenna 50 can be received in the housing 30. In at least one embodiment, the electronic device 100 can be, but no limited to a mobile phone, a tablet computer. The housing 30 can be a rear cover of the electronic device 100. The electronic device 100 can further include other components, which are not shown in this embodiment. For example, the electronic device 100 can further include a printed circuit board, a process module or other components received in the housing 30. The display module 10 can be omitted, if the electronic device 100 does not display any information.

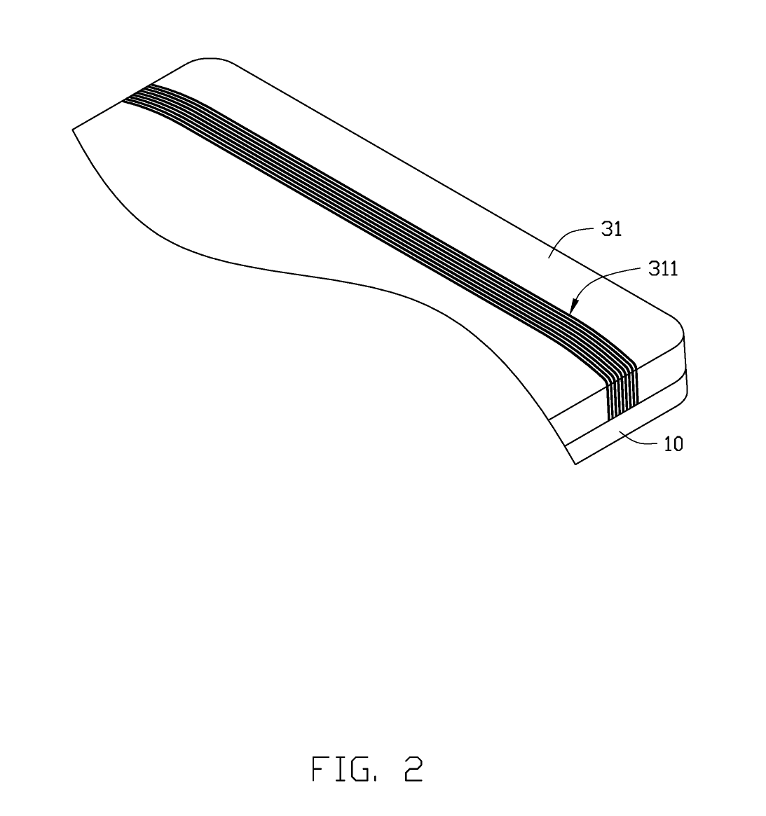

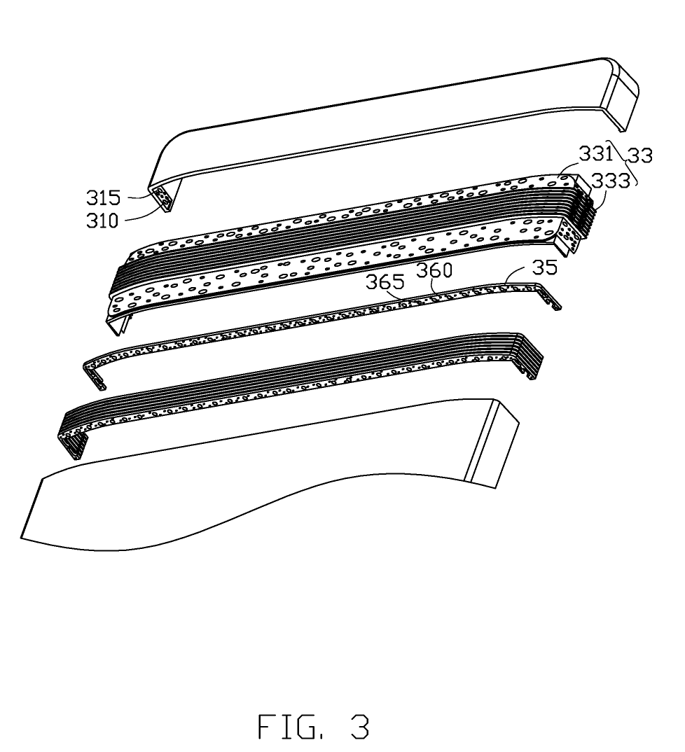

FIG. 2 illustrates that the housing 30 can include a metallic base 31. The metallic base 31 can define a slit 311 by punching, or the like. FIG. 3 illustrates that the housing 30 can further include a plurality of metallic members 35. The metallic members 35 can be arranged at intervals in the slit 31 in order (shown in FIG. 2). The metallic base 31 and the metallic members 35 can be made of a material: but not limited to, stainless steel, aluminum, aluminum alloy, magnesium, magnesium alloy, titanium, titanium alloy, copper or copper alloys. The housing 30 can further include a non-conductive member 33 formed by insert molding. The non-conductive member 33 can be formed integrally with the metallic members 35. The non-conductive member 33 can be formed between each two neighboring metallic members 35, and the non-conductive member 33 can be also formed between the metallic base 31 and the metallic members 35 adjacent to the metallic base 31. The metallic base 31 and the metallic members 35 can be bonded with the non-conductive member. The non-conductive member 33 can include a base portion 331 and a plurality of connecting portions 333. The metallic members 35 can be connected by the connecting portions 333, and the metallic base 31 and the metallic members 35 adjacent to the metallic base 31 can be connected by the base portion 331 and the connecting portion 333 near the metallic base 31.

The non-conductive member 33 can be made of a thermoplastic, a thermosetting plastic, a ceramic, or other non-conductive materials.

The thermoplastic can be selected from a group consisting of polybutylene terephthalate (PBT), polyphenylene sulfide (PPS), polyethylene terephthalate (PET), polyether ether ketone (PEEK), polycarbonate (PC) and polyvinyl chloride polymer (PVC). The thermosetting plastic can be selected from a group consisting of a polyurethane resin, an epoxy, and a polyurea resin.

In at least one exemplary embodiment, the metallic base 31 can be made of metal which can be selected from a group consisting of aluminium, aluminium alloy, magnesium, magnesium alloy, titanium, titanium alloy, copper and copper alloy.

The antenna 50 can be coupled with the metallic base 31, and the metallic base 31 can be used as a part of an antenna assembly of the electronic device 100. In other embodiments, the antenna 50 is not used as a part of the antenna assembly. The antenna 50 is not coupled with the metallic base 31, and the antenna 50 can be arranged near the slit 311. Signals of the antenna 50 can pass the slit 311 of the housing 31, so the antenna 50 can have a high radiation efficiency.

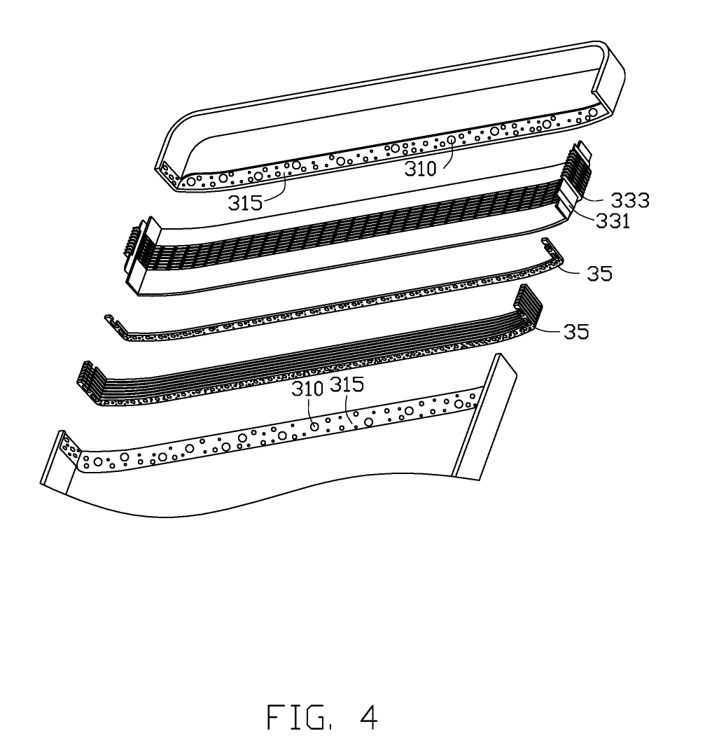

FIG. 4 illustrates that an inner wall of the metallic base 31 can define two receiving grooves 315. The two receiving grooves 315 can be defined at two sides of the slit 311 and near the slit 311. Bottom surfaces of the receiving grooves 315 can define a plurality of first micro holes 310 formed by chemical etching method. In at least one embodiment, the receiving groove 315 can be substantially U-shaped. In other embodiments, the slit 311 and the receiving groove 315 can be formed by CNC machining or other methods.

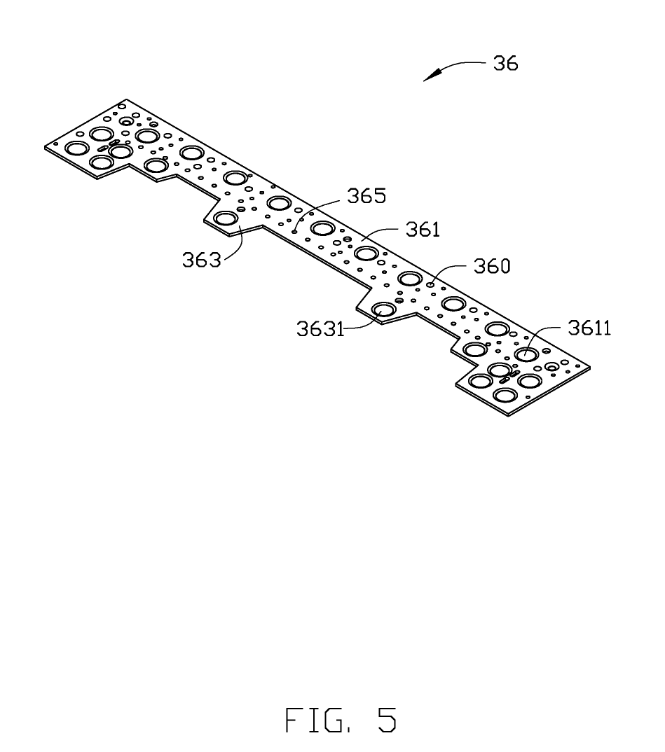

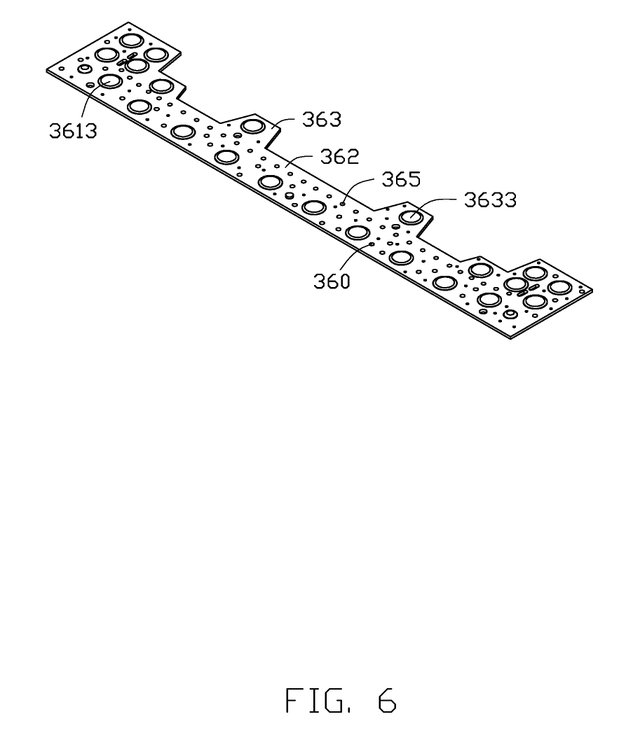

Each metallic members 35 can be made from a metallic piece. FIG. 5 illustrates that a metallic piece 36 can include a first surface 361. A middle portion of the metallic piece 36 can include two extending portion 363 extending toward one direction. Each extending portion 363 can define a recessed hole 3631 on the first surface 361. The first surface 361 of the metallic pieces 36 can define a plurality of positioning holes 3611 at two ends thereof. FIG. 6 illustrates that the metallic piece 36 can include a second surface 362. The second surface 362 can be opposite to the first surface 361 (show in FIG. 5). Each extending portion 363 can include a protrusion 3633 on the second surface 362, and the second surface 362 of the metallic pieces 36 can include a plurality of bosses 3613 at two ends thereof. Each metallic piece 36 can further include a plurality of through holes 365 arranged spaced from each other. Each through hole 365 can run through the first surface 361 and the second surface 362. The plurality of the through holes 365 can be arranged along a virtual cured line. The first surface 361 and the second surface 362 can further include a plurality of second micro holes 360 formed by chemical etching.

FIG. 4 and FIG. 5 illustrate that the base portion 331 can be partially received in the receiving grooves 315 and partially embedded into the first micro holes 310. The base portion 331 can be fixed at the bottom surfaces of the two receiving grooves 315. Each connecting portion 333 can be partially embedded into the through holes 365 and the second micro holes 360, thus the connecting portions 333 can be fixed with the metallic members 35, and the two connecting portions 333 near the metallic base 31 can protrude out of the through hole 365 and connected to the base portion 331. In at least one embodiment, each two neighboring connecting portions 333 can be fixed together, as at least one through hole 365 of the each metallic member 35 is filled with the connecting portion 333. The non-conductive member 33 can be, but not limited to plastic or ceramic.

In at least one exemplary embodiment, each metallic member 317 has a width of about 0.15 mm to about 1.0 mm along a direction from the connecting portion 333 to the base portion 331. Each connecting portion 333 has a width of about 0.02 mm to 0.7 mm from the connecting portion 333 to the base portion 331.

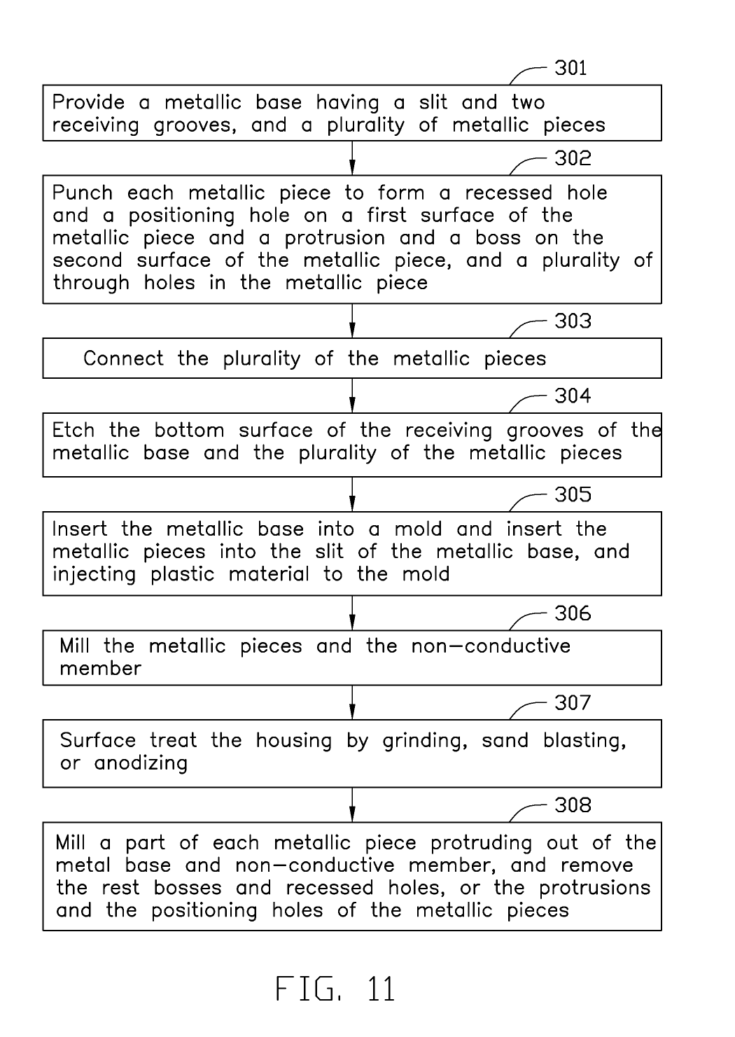

Referring to FIG. 11, a flowchart is presented in accordance with an example embodiment which is being thus illustrated. The example method is provided by way of example, as there are a variety of ways to carry out the method. The method described below can be carried out using the configurations illustrated in FIG. 1 through FIG. 6, for example, and various elements of these figures are referenced in explaining example method. Each block shown in FIG. 11 represents one or more processes, methods or subroutines, carried out in the example method. Additionally, the illustrated order of blocks is by example only and the order of the blocks can change according to the present disclosure. The example method can begin at block 301.

At block 301, the metallic base 31 having the slit 311 and the plurality of metallic pieces 36 are provided. The inner wall of the metallic base 31 defines two receiving grooves 315, and the two receiving grooves 315 are arranged at two sides of the slit 311 and adjacent to the slit 311. Each metallic piece 36 includes the first surface 361 and the second surface 362, and the middle portion of the metallic piece 36 includes two protrusion portions 363. In at least one exemplary embodiment, a thickness of the metal base is less than 1.2 mm. Preferably, the thickness of the metal base is about 0.3 mm to about 0.8 mm.

The metal base 31 can be made by casting, punching, or CNC. The metal base 31 having a desired three dimensional shape is provided. The metal base 31 can be made of metal which can be selected from a group consisting of aluminium, aluminium alloy, magnesium, magnesium alloy, titanium, titanium alloy, copper and copper alloy.

At block 302, each metallic piece 36 is punched to form the recessed holes 3631 and the positioning holes 3611 on the first surface 361, the protrusions 3633 and the bosses 3613 on the second surface 362, and the through holes 365 through the first surface 361 and the second surface 362.

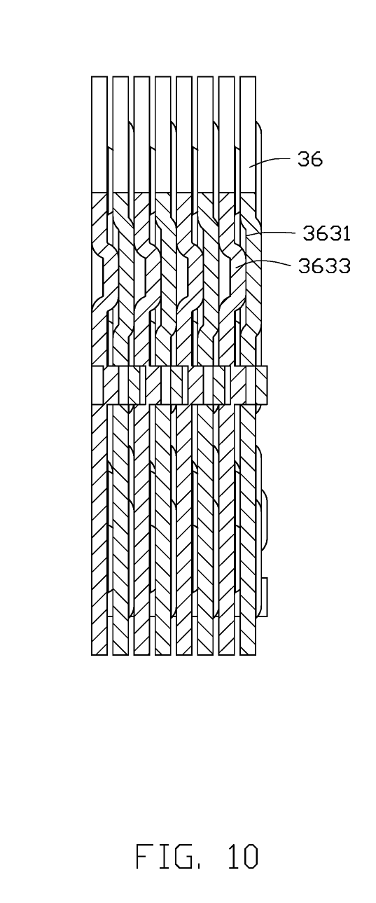

At block 303, the metallic pieces 36 are connected, and gaps are formed between neighboring metallic pieces 36. FIG. 10 illustrates that the recessed hole 3631 of one metallic piece 36 is coupled to the protrusion 3633 of one neighboring metallic piece 36. Referring to FIG. 4 and FIG. 5 again, the positioning hole 3611 of the metallic piece 36 is coupled to the boss 3613 of the neighboring metallic piece 36. The protrusion 3633 of the metallic piece 36 is coupled to the recesses hole 3631 of another neighboring metallic piece 36, and the boss 3613 of the metallic piece 36 is coupled to the positioning hole 3611 of the another neighboring metallic piece 36.

At block 304, the bottom surface of the receiving grooves 315 of the metallic base 31 are chemical etched to form the plurality of the first micro holes 310. The metallic pieces 36 are chemical etched to form the plurality of the second micro holes 360 on the first surfaces 361 and the second surfaces 362.

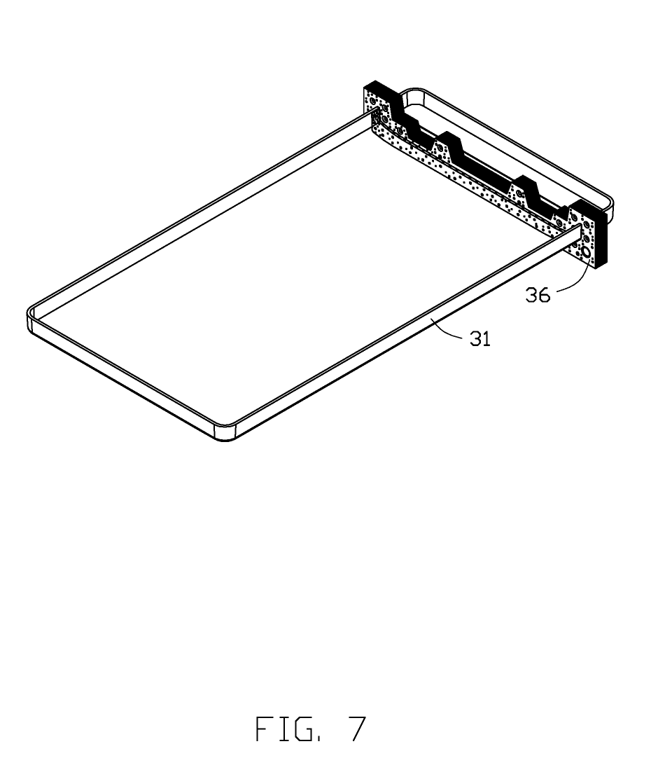

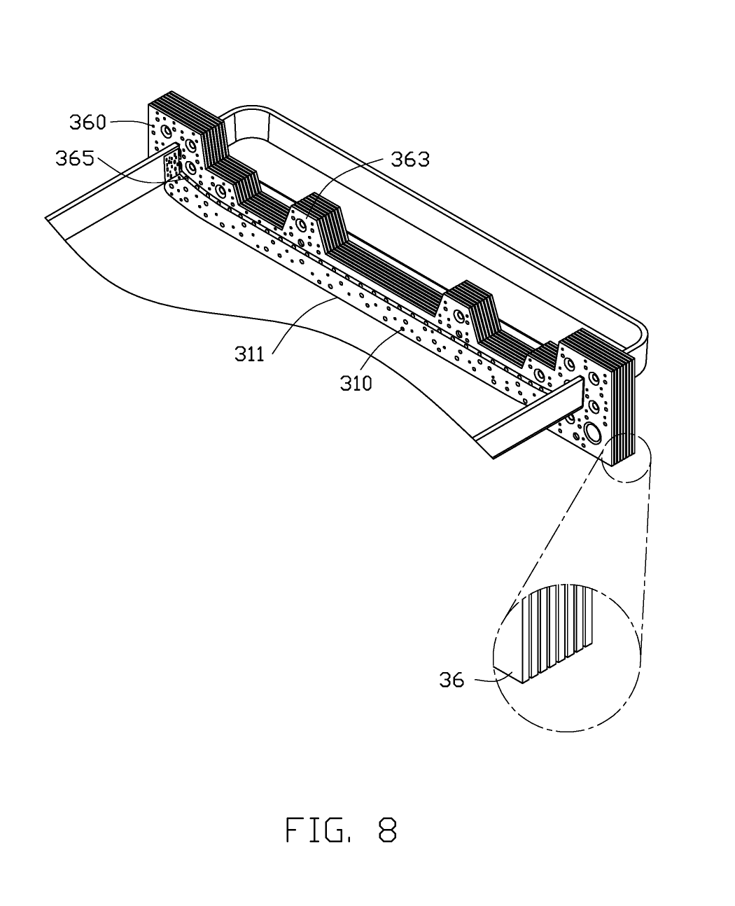

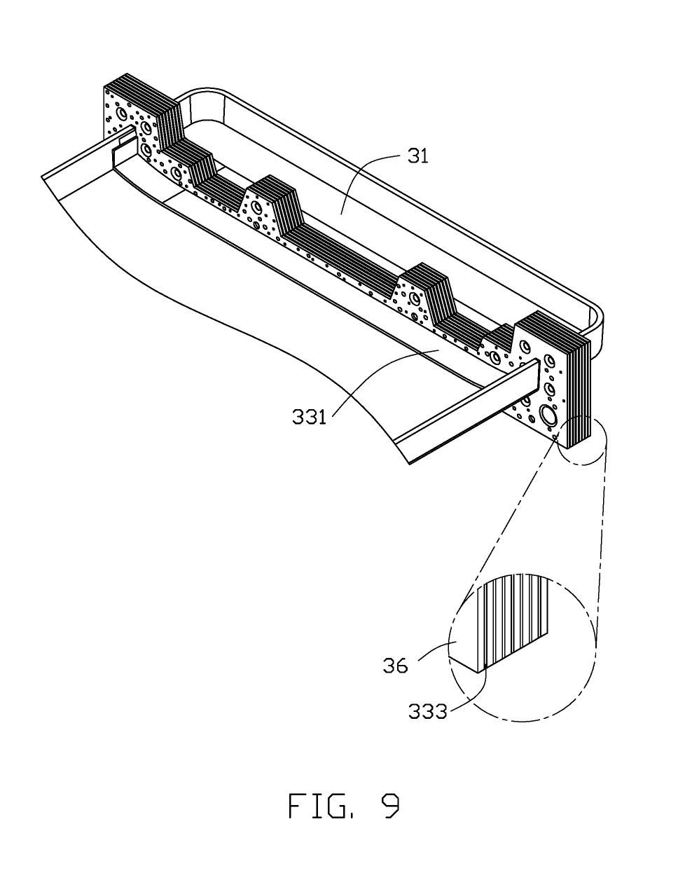

At block 305, the metallic base 31 is inserted into a mold (not shown). FIG. 7 and FIG. 8 illustrate that the metallic pieces 36 which are connected to each other are inserted into the slit of the metallic base 31. Melted plastic is injected into the mold. FIG. 9 illustrates that the melted plastic flows into the space between the metallic pieces 36, and the through holes 365, the receiving grooves 315, the first micro holes 310, and the second micro holes 360 are filled with the melted plastic. The plastic is cooled to form the non-conductive member 33 including the base portion 331 and the plurality of connecting portions 333.

The material for making the non-conductive member 33 can be a thermoplastic or a thermosetting plastic. The thermoplastic can be selected from a group consisting of polybutylene terephthalate (PBT), polyphenylene sulfide (PPS), polyethylene terephthalate (PET), polyether ether ketone (PEEK), polycarbonate (PC) and polyvinyl chloride polymer (PVC). The thermosetting plastic can be selected from a group consisting of a polyurethane resin, an epoxy, and a polyurea resin.

It is to be understood that the non-conductive member 33 can also be made of ceramic, or other non-conductive materials.

At block 306, the metallic pieces 36 and the non-conductive member 33 are milled after the plastic is molded. The protrusions 3633 and the recessed holes 3631, or the bosses 3613 and the positioning hole 3611 can be reserved for surface treatment.

At block 307, the surface of the housing 30 is treated. The housing 30 can be surface treated by grinding, sand blasting, anodizing or physical vapor deposition.

At block 308, the metallic piece 36 is milled to remove a part of the metallic piece 36 protruding out of the metallic base 31 and the non-conductive member 33, and the rest protrusions 3633 and the recessed holes 3631, or the bosses 3613 and the positioning holes 3611 are removed.

The housing 30 can define the slit 311, the metallic members 35 can be inserted into the slit 311 at intervals and fixed by the non-conductive member 35. When the antenna 50 is arranged near the slit 311, the signal of the antenna 50 can pass the housing 30 smoothly. When manufacturing the housing 30, as long as a height of the protrusion 3633 is equal to a height of the recessed hole 3161, or a height of the boss 3613 is equal to a height of the positioning hole 3611, the metallic pieces 36 can be evenly spaced from each other. The metallic pieces 36 would not be shifted during injecting the plastic material, so the metallic pieces 36 has a higher precision. Moreover, the antenna 50 can be coupled with the metallic base 31, thus the metallic base 31 can act as one part of the antenna 50, and the radiation efficiency of the antenna 50 can be improved.

In other embodiments, the processes in block 306 and 307 can be omitted if there is no need to surface treat the housing 30. The process in block 308 can be omitted if the metallic piece 36 provided in block 301 is same as the metallic member 35.

In other embodiments, the receiving grooves 315 in the metallic base 31 can be omitted as long as the base portion 331 can be fixed to the inner wall of the metallic base 31. The through holes 365 can be omitted as long as the base portion 331 can be fixed to the metallic base 31 and the metallic piece 36 adjacent to the metallic base 31. The micro hole 310 in the receiving groove 315 and the second micro hole 360 in the metallic members 35 can be omitted, and the process in block 303 can be also omitted.

The embodiments shown and described above are only examples. Many details are often found in the art such as the other features of a housing, an electronic device having the housing, and a method of manufacturing the housing. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size and arrangement of the parts within the principles of the present disclosure up to, and including, the full extent established by the broad general meaning of the terms used in the claims. It will therefore be appreciated that the embodiments described above may be modified within the scope of the claims.

What is claimed is:

1. A housing comprising:
a metallic base defining a slit;
a plurality of metallic members arranged in the slit at intervals; and
a non-conductive member formed between two neighboring metallic members of the plurality of metallic members, and the non-conductive member formed between the metallic base and the metallic members adjacent to the metallic base;
wherein the non-conductive member is integrally formed with the metallic base and the plurality of the metallic members to form the housing, and the plurality of the metallic members and the metallic base are connected by the non-conductive member.

2. The housing as claimed in claim 1, wherein the non-conductive member comprises a base portion and a plurality of connecting portions, the metallic base and the metallic pieces adjacent to the metallic base are connected by the base portion, and the two neighboring metallic members are connected by one of the connecting portions.

3. The housing as claimed in claim 2, wherein an inner wall of the metallic base defines two receiving grooves defined at two sides of the slit and near the slit, and the base portion is received in the receiving grooves and fixed to the metallic base.

4. The housing as claimed in claim 3, wherein the receiving grooves define a plurality of first micro holes, and the base portion is partially embedded into the first micro holes of the receiving grooves.

5. The housing as claimed in claim 2,
wherein each metallic member comprises a first surface and a second surface opposite to the first surface, and each metallic member defines a plurality of through holes through the first surface and the second surface; and
wherein the base portion and the plurality of the connecting portions are partially embedded into the through holes by insert molding, thereby the base portion is connected to the metals members adjacent to the base portion, and the two neighboring metallic members are connected.

6. The housing as claimed in claim 5, wherein each first surface and each second surface of the metallic members defines a plurality of second micro holes, and each connecting portion is partially embedded into the second micro holes of two of the plurality of metallic members which are joined.

7. The housing as claimed in claim 2, wherein each metallic member has a width of about 0.15 mm to about 1.0 mm along a direction from the connecting portion to the base portion, and each connecting portion has a width of about 0.02 mm to 0.7 mm along a direction from the connecting portion to the base portion.

8. The housing as claimed in claim 1, wherein the metallic base is made of the material selected from a group consisting of stainless steel, aluminium, aluminium alloy, magnesium, magnesium alloy, titanium, titanium alloy, copper and copper alloy.

9. The housing as claimed in claim 1, wherein the non-conductive member is selected from a group consisting of polybutylene terephthalate, polyphenylene sulfide, polyethylene terephthalate, polyether ether ketone, polycarbonate, polyvinyl chloride polymer, polyurethane resin, epoxy, and polyurea resin.

10. A method for manufacturing a housing, the method comprising:
providing a metallic base and a plurality of metallic pieces, the metallic base having a slit and two receiving grooves;
inserting the metallic base into a mold and inserting the metallic pieces into the slit of the metallic base, the metallic pieces being spaced from each other; and
injecting plastic material to the mold;
wherein the plastic material flows into spaces between two neighboring metallic pieces of the plurality of metallic pieces, and the plastic material flows into spaces between the metallic base and the metallic pieces adjacent to the metallic base; and
wherein a non-conductive member is formed after the plastic material is cooled, and the plurality of the metallic pieces, and the metallic base and the metallic pieces adjacent to the metallic base are connected by the non-conductive member.

11. The method as claimed in claim 10,
wherein the method further comprises a step of punching each metallic piece to form a plurality of through holes therein before connecting the metallic pieces; and
wherein the through holes are filled with the plastic material after the plastic material is injected into the mold.

12. The method as claimed in claim 10,
wherein the method further comprises a step of punching each metallic piece to form a recessed hole on a first surface of the metallic piece and a protrusion on a second surface of the metallic piece opposite to the first surface before connecting the metallic pieces; and
wherein each protrusion of the metallic piece is coupled to the recessed hole of the neighboring metallic piece after the metallic pieces are connected.

13. The method as claimed in claim 10,
wherein the method further comprises a step of punching each metallic piece to form a positioning hole on a first surface of the metallic piece and a boss on a second surface of the metallic piece opposite to the first surface before connecting the metallic pieces; and
wherein each positioning hole of the metallic piece is coupled to the boss of the neighboring metallic piece after the metallic pieces are connected.

14. The method as claimed in claim 10, wherein the method further comprises a step of milling the metallic pieces after injecting the plastic material to the mold to remove a part of each metallic piece protruding out of the metallic base.

15. An electronic device, comprising:
a housing comprising:
a metallic base defining a slit,
a plurality of metallic members arranged in the slit at intervals, and
a non-conductive member formed between two neighboring metallic members of the plurality of metallic members, and between the metallic base, and the non-conductive member formed between the metallic members adjacent to the metallic base; and
an antenna received in the housing;
wherein the non-conductive member is integrally formed with the metallic base and the plurality of the metallic members to form the housing, and the plurality of the metallic members and the metallic base are connected by the non-conductive member.

16. The electronic device as claimed in claim 15, wherein the non-conductive member comprises a base portion and a plurality of connecting portions, the metallic base and the metallic pieces adjacent to the metallic base are connected by the base portion, and the two neighboring metallic members are connected by one of the connecting portions.

17. The electronic device as claimed in claim 16, wherein an inner wall of the metallic base defines two receiving grooves defined at two sides of the slit and near the slit, and the base portion is received in the receiving grooves and fixed to the metallic base.

18. The electronic device as claimed in claim 17, wherein the two receiving grooves defines a plurality of first micro holes, and the base portion is partially embedded into the first micro holes of the receiving grooves.

19. The electronic device as claimed in claim 15,
wherein each metallic member comprises a first surface and a second surface opposite to the first surface, and each metallic member defines a plurality of through holes through the first surface and the second surface; and
wherein the base portion and the plurality of the connecting portions are partially embedded into the through holes by insert molding, thereby the base portion is connected to the metallic members adjacent to the base portion, and the two neighboring metallic members are connected to each other.

20. The electronic device as claimed in claim 19, wherein each first surface and each second surface of the metallic members defines a plurality of second micro holes, and each connecting portion is partially embedded into the second micro holes of two of the plurality of metallic members which are joined.
